(19) United States
(12) Patent Application Publication
(10) Pub. No.: US 2022/0222803 A1
(43) Pub. Date: Jul. 14, 2022

(54) LABELING PIXELS HAVING DEFECTS

(71) Applicant: Hewlett-Packard Development Company, L.P., Spring, TX (US)

(72) Inventors: Qian Lin, Palo Alto, CA (US); Augusto Cavalcante Valente, Campinas (BR); Otavio Basso Gomes, Campinas (BR); Deangeli Gomes Neves, Campinas (BR); Guilherme Augusto Silva Megeto, Campinas (BR); Marcos Henrique Cascone, Campinas (BR); Fabio Vinicius Moreira Perez, Campinas (BR)

(73) Assignee: Hewlett-Packard Development Company, L.P., Spring, TX (US)

(21) Appl. No.: 17/614,000

(22) PCT Filed: Sep. 26, 2019
(86) PCT No.: PCT/US2019/053262

§ 371 Date: Nov. 24, 2021

(51) Int. Cl. G06T 7/00; G06N 3/04; G06T 7/33

(52) U.S. Cl. CPC G06T 7/001; G06N 3/04; G06T 2207/20084; G06T 2207/30144; G06T 2207/20081; G06T 7/337

(57) ABSTRACT

An example method includes capturing a target image of a print product printed by a printer. The method also includes aligning the target image with a reference image corresponding to the target image. The method further includes analyzing the reference image and the target image using a machine learning model. The method includes labeling each of a plurality of pixels as having a defect based on the analysis. The label is applied to each individual pixel of the plurality of pixels.

### BACKGROUND

A printer may form a print product on a print target. For example, a two-dimensional (2D) printer may deliver a colorant to a print target that is a 2D media to produce a print product that includes an image on a surface of the 2D media. A three-dimensional (3D) printer may fuse, bind, or solidify material on a print target (e.g., a print bed) to produce a 3D object that includes a plurality of attached layers. The 3D printer may also deliver colorant during production of the 3D object to generate a 3D object that includes a plurality of colors on a surface of the 3D object. Delivering colorant to a 2D or 3D print target may include delivering ink with a printhead, delivering and fusing toner onto the print target, delivering a printing fluid that includes the colorant and removing excess carrier fluid, or the like.

### BRIEF DESCRIPTION OF THE DRAWINGS

FIG. 1 is a block diagram of an example system to label pixels having defects. according to aspects of the present disclosure.

FIG. 2 is a block diagram of another example system to label pixels having defects. according to aspects of the present disclosure.

FIG. 3 is a flow diagram of an example method to label pixels having defects according to aspects of the present disclosure.

FIG. 4 is a flow diagram of another example method to label pixels having defects according to aspects of the present disclosure.

FIG. 5 is a block diagram of an example computer-readable medium including instructions that cause a processor to label pixels having defects according to aspects of the present disclosure.

FIG. 6 is a block diagram of another example computer-readable medium including instructions that cause a processor to label pixels having defects according to aspects of the present disclosure.

### DETAILED DESCRIPTION

A printer may produce a print product based on a file. For example, the file may include data representing an image to be printed. As used herein, the term “image” refers to a multi-dimensional array of values or compressed information corresponding to a multi-dimensional array of values regardless of whether those values are rendered. The image may include text, pictures, a model, or the like. In some examples, the file may be interpretable by the printer, or the printer or another device may convert the file into a format interpretable by the printer to produce the print product.

In some examples, the print product may deviate from what is specified in the file due to a defect caused by the printer. For example, an inkjet nozzle may clog or fail, which may cause streaks on the print product where the inkjet nozzle failed to deliver printing fluid (e.g., ink, three-dimensional (3D) printing fluid, etc.) to the print product. A gap between the inkjet nozzle may be too large or too small, which may create smearing or other artifacts. An optical photoconductor or fuser may have defective regions, which may produce spots on the print product. The print product may not be useable due to the defect caused by the printer. For example, the print product may be intended for sale or sharing, and the defect may mar the appearance such that the print product can no longer be sold or shared.

Defects in a print product can be detected by manual inspection of the print product or of test print products printed before, with, or after printing of a production print product. However, manual inspection is time consuming and susceptible to human error. Alternatively, defects can be detected by automatic analysis of the print product. For example, a target image captured of the print product can be compared to a reference image. The reference image may be an image used to print a print product or an image generated from a file used to print the print product. However, the target image may deviate from the reference image due to properties of the printer. Accordingly, the comparison of the target image to the reference image may be tailored to a specific printer, or a global quality measure may be computed to evaluate whether the target image contains a defect. The comparison may not indicate the particular location of the defect in the image. The location of the defect and the cause of the defect may be determined by manual inspection of the image, which may be time consuming. Accordingly, the detection of defects in print products could be improved by automatically detecting the locations of defects in a print product. The detection of defects could be further improved by automatically determining the cause of the defect in the print product.

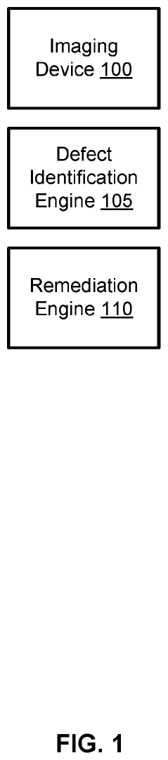

FIG. 1 is a block diagram of an example system to label pixels having defects. according to aspects of the present disclosure. The example shown includes an imaging device 100, a defect identification engine 105, and a remediation engine 110. As used herein, the term “engine” refers to hardware (e.g., analog or digital circuitry, a processor, such as an integrated circuit, or other circuitry) or a combination of software (e.g., programming such as machine- or processor-executable instructions, commands, or code such as firmware, a device driver, programming, object code, etc.) and hardware. Hardware includes a hardware element with no software elements such as an application specific integrated circuit (ASIC), a Field Programmable Gate Array (FPGA), etc. A combination of hardware and software includes software hosted at hardware (e.g., a software module that is stored at a processor-readable memory such as random-access memory (RAM), a hard-disk or solid-state drive, resistive memory, or optical media such as a digital versatile disc (DVD), and/or executed or interpreted by a processor), or hardware and software hosted at hardware.

The imaging device 100 may capture a target image of a print product printed by a printer. The imaging device 100 may be a scanner, a camera, or the like. The imaging device 100 may be included in and mechanically coupled to the printer. For example, the imaging device 100 may be positioned inline with the printer to capture images of print products as they leave the printer. The imaging device 100 may capture images of the print product as it is printed by the printer. For example, the imaging device 100 may capture images of each layer of a 3D print product as the print product is formed. The imaging device 100 may capture images in any of various electromagnetic spectrums, such as the ultraviolet, visible, or infrared spectrums. The imaging device 100 may capture images having a plurality of colors in a spectrum. For example, the imaging device 100 may include color filters that allow the imaging device 100 to capture images having colors corresponding to the color filters.

The defect identification engine 105 may analyze the reference image and the target image using a machine learning model. As used herein, the term “machine learning model” refers to data usable to implement a trained machine learning device using a processor. The reference image may be an image corresponding to the target image. For example, the reference image may be an image used to print a print product, an image generated from a file used to print the print product, or an otherwise generated image of what the target image should look like. The reference image and the target image may be provided as inputs to the machine learning model. The defect identification engine 105 may label each of a set of pixels as having a defect based on the analysis. For example, the machine learning model may include an output for each pixel. The output may indicate whether that pixel has a defect, or the defect identification engine 105 may determine based on the output whether that pixel has a defect.

The remediation engine 110 may adjust a hardware configuration of the printer to remediate a cause of the defect in each of the plurality of pixels. For example, the remediation engine 110 may change a printer setting that affects a physical property of a hardware component, that changes how a hardware component is used, or the like. The remediation engine 110 may adjust the hardware configuration by indicating to a user or another system (e.g., a system that manages printer maintenance) to adjust or replace a hardware component in the printer. The adjustment to the hardware configuration may prevent the defect from occurring in additional print products.

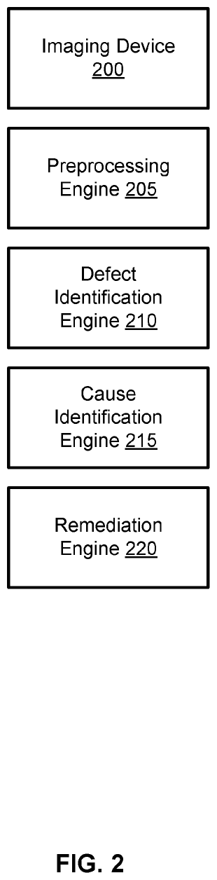

FIG. 2 is a block diagram of another example system to label pixels having defects according to aspects of the present disclosure. The example shown includes an imaging device 200, a preprocessing engine 205, a defect identification engine 210, a cause identification engine 215, and a remediation engine 220. The imaging device 200 may be an example of, or include aspects of, the corresponding element or elements described with reference to FIG. 1. The imaging device 200 may capture a target image of a print product printed by a printer.

The preprocessing engine 205 may identify which reference image corresponds to the target image. The preprocessing engine 205 may identify the reference image based on a predetermined relationship between the position or timing of output of the print product that was captured and the reference images in memory, based on image recognition or comparison, based on an identifier (e.g., a barcode, a steganographic identifier, etc.), because the printer is producing a plurality of identical print products, or the like. The preprocessing engine 205 may align the target image with a reference image corresponding to the target image. The preprocessing engine 205 may align the reference image and target image by performing feature detection using a feature detection technique and aligning features, correlating grayscale values and aligning based on the correlation, or the like.

In some examples, the preprocessing engine 205 may also split the target image and the reference image into a set of target patches and a set of reference patches. Each patch may include a portion of the image (e.g., a rectangular array of pixels) that is smaller than the whole image. Splitting the images into patches may allow arbitrary sized images to be processed by a machine learning model that inputs fixed sized images. Using patches may also allow for a simpler machine learning model that is faster to train or faster to execute. The preprocessing engine 205 may split the target image and the reference image into a set of overlapping patches. For example, the preprocessing engine 205 may use a stride distance to determine the location of the next patch, and the stride distance may be smaller than the width or height of the patch.

In some examples, the preprocessing engine 205 may perform a detail preserving resize of the target image and the reference image to produce resized images that can be input into the machine learning model. For example, the preprocessing engine 205 may perform a plurality of downsamples and interpolations on each image to reach an image size that can be input into the machine learning model (e.g., a predetermined size). Like generating patches, the detail preserving resize may allow arbitrary sized images to be processed according to a machine learning model that inputs fixed sized images and may allow for a simpler machine learning model that is faster to train or faster to execute.

The preprocessing engine 205 may concatenate the target image with the reference image to produce an input vector. For example, the preprocessing engine 205 may append a vector for the reference image to a vector for the target image (or vice versa). The target image and the reference image may each include a plurality of color channels, such as red, green, and blue (RGB) color channels, cyan, magenta, yellow, and black (CMYK) color channels, or the like. Accordingly, the input vector may include a grayscale value for each color channel of each pixel of the target image and a grayscale value for each color channel of each pixel of the reference image. In some example, the grayscale values for the target and reference images may be interleaved or intermixed rather than appended to produce the input vector.

The defect identification engine 210 may be an example of, or include aspects of, the corresponding element or elements described with reference to FIG. 1. In some examples, the defect identification engine 210 may analyze the input vector using a machine learning model by using a neural network to generate a set of scores for each pixel. For example, the machine learning model may include indications of the structure or weights of a neural network that can be simulated by the defect identification engine 210 based on the indications of the structure or weights. The neural network may include a layer that includes a set of kernel sizes. For example, the input vector may be convolved with kernels of various sizes to detect defects at different scales.

The defect identification engine 210 may use the scores generated using the neural network to determine whether a defect is present. The defect identification engine 210 may generate a plurality of scores for each pixel, and each score may be indicative of whether a particular type of defect is present in the pixel. The defect identification engine 210 may generate the set of scores as a set of softmax outputs for each pixel, and each softmax output for that pixel corresponds to one of a set of defects that may be present. In some examples, the neural network may include a semantic segmentation network. Because the defect identification engine 210 may use a neural network that includes kernels of various sizes but may output a score for each pixel indicating whether a defect is present, the defect identification engine 210 may determine whether a pixel includes a defect based on data from surrounding pixels while also determining whether an individual pixel includes a defect. In addition, considering surrounding pixels may allow the defect identification engine 210 to robustly detect defects in individual pixels without detecting false positives across different printers and despite pixel differences unrelated to defects introduced by the printing and image capture process.

The defect identification engine 210 may apply a label to each individual pixel of the set of pixels. The label may indicate whether a defect is present in the pixel or which type of defect is present in the pixel. The defect identification engine 210 may include a label for each type of defect that is present in a pixel. For example, the defect identification engine 210 may label a pixel as having a first defect and label the pixel as having a second defect when there are multiple defects present in that pixel.

The defect identification engine 210 may determine whether to apply a label by evaluating the scores generated using the neural network. The defect identification engine 210 may compare each score for a pixel to a threshold to determine whether a defect corresponding to that score is present in that pixel. There may be a single threshold for all defects, a threshold for each type of defect, or the like. For example, the defect identification engine 210 may compare a score for a pixel to the threshold for that type of score to identify a defect in a color channel. The threshold may be predetermined, user specified, or the like. Based on the score exceeding the threshold, the defect identification engine 210 may apply a label indicating the type of defect corresponding to that score is present.

In some examples, each defect may correspond to a color channel. For example, each defect may be an increase or decrease in the color channel. The defect identification engine 210 may apply, to the pixel, a label that indicates the color channel that includes the defect. In some examples, the plurality of color channels of the target and reference images is in a first color space, and the color channel in which the defect is identified is in a second color space. For example, the target and reference image may be in an RGB color space, and the defect identification engine 210 may identify defects in a CMYK color space.

The machine learning model may be trained based on a training set that includes a set of target images which may or may not include defects, a set of reference images corresponding to the target images, and a set of defect maps indicating the locations or types of the defects in the corresponding target images. The set of target images may include defects in each of the color channels, such as increases or decreases in each of the color channels. Training the machine learning model may include the defect identification engine 210 generating a defect map that includes labels of defects for each pixel based on a reference image and a target image from the training set. The defect map from the training set may be compared to the defect map generated by the defect identification engine 210 to determine errors in the defect map generated by the defect identification engine 210. The machine learning model may be updated based on the errors. For example, errors may be backpropagated through a neural network to determine new weights for the network.

In examples in which the preprocessing engine 205 generates target and reference patches, the defect identification engine 210 may analyze each target patch and each corresponding reference patch using the machine learning model. For example, the preprocessing engine 205 may generate an input vector from each target patch and corresponding reference patch, and the defect identification engine 210 may analyze each input vector. The defect identification engine 210 may combine results of the analysis of each target patch and corresponding reference patch to generate the labels for the pixels. In examples in which the patches overlap, the defect identification engine 210 may combine the scores for each type of defect for a pixel appearing in multiple patches to produce a combined score for each type of defect for each pixel. For example, the defect identification engine 210 may combine the scores by determining an average, median, maximum, minimum, etc. score. The defect identification engine 210 may compare the combined score to the threshold to determine whether a defect is present. Alternatively, or in addition, the defect identification engine 210 may compare each score to the threshold and combine the results of the comparison (e.g., using an AND operation, using an OR operation, majority rule, etc.).

In examples in which the preprocessing engine 205 resizes the target and reference images, the defect identification engine 210 may analyze the resized images using the machine learning model. The defect identification engine 210 may produce an output from the machine learning model that has the same dimensions in pixels as each of the resized input images. The defect identification engine 210 may resize the output to be a same size as the original target and reference images. The output may be a defect map, which may include a plurality of labels for some pixels. The defect identification engine 210 may upsample or interpolate the output to be the same size at the original target and reference images. For example, the defect identification engine 210 may generate an upsampled defect map with labels corresponding to the pixels of the original target image.

The cause identification engine 215 may identify a cause of the defect based on the plurality of pixels labeled as having a defect. For example, the cause identification engine 215 may receive a defect map that includes labels for pixels that include defects from the defect identification engine 215, and the cause identification engine 215 may analyze the defect map to determine a cause of the defect. The cause identification engine 215 may identify the cause as an improper setting, a part failure remediable by changing a setting, a part failure remediable by replacing a part, or the like. The cause identification engine 215 may identify which part is causing the defect or may identify a location in the part cause the defect. For example, the cause identification engine 215 may determine a gap for a printhead or a charging gap for an optical photoconductor is causing the defect, may determine that a printhead is causing the defect and identify a particular nozzle on the printhead causing the defect, may identify a location on an optical photoconductor that is causing the defect, or the like.

In some examples, the cause identification engine 215 may detect features in the defect map using a feature detection technique and determine the defect based on the detected features. The cause identification engine 215 may identify a streak based on detecting a line in the image aligned with a nozzle. The cause identification engine 215 may identify banding or smearing based detecting an area of defects wider than a few pixels and extending in a direction aligned with a plurality of nozzles. In some examples, the cause identification engine 215 may include a machine learning model to identify defects based on a defect map. The machine learning model may include a neural network, such as a convolutional neural network, trained to classify defects based on the defect map. The machine learning model may be trained using a training set that includes defect maps and corresponding indications of the cause of the defects in the defect map.

In some examples, the defect identification engine 210 may label a plurality of pixels as having a decreased color channel, and the cause identification engine 215 may identify a nozzle corresponding to the plurality of pixels having the decreased color channel. For example, the nozzle may be clogged, and the cause identification engine 215 may identify which nozzle is clogged based on the labels. The imaging device 200 may be in a fixed location relative to the printer, so there may be a deterministic relationship between pixels in the target image and nozzles on the printer. The cause identification engine 215 may retrieve a stored indication of the relationship between pixels and nozzles to determine which nozzle is clogged based on which pixels include labels. The indication of the relationship may have been previously stored by a user or manufacturer, may have been automatically determined based on printing a test page or attempting to select a nozzle to correct a previous defect, or the like.

The cause identification engine 215 may determine a severity of the defect. The cause identification engine 215 may determine the severity based on the number of pixels that includes labels. The cause identification engine 215 may determine the severity by comparing the label for a pixel to colors of surrounding pixels to determine how noticeable the defect is. The cause identification engine 215 may decide whether to remediate the defect based on the severity exceeding a threshold. For example, a print product with few pixels having defects or with not too noticeable defects may still be acceptable, so the cause identification engine 215 may decide not to remediate the defect. In contrast, the cause identification engine 215 may decide remediation should be performed for a print product with many defects or visibly striking defects. The threshold may be specified by a user, for example, based on the intended usage of the print product.

The remediation engine 220 may be an example of, or include aspects of, the corresponding element or elements described with reference to FIG. 1. The remediation engine 220 may adjust a hardware configuration to remediate the identified cause. The hardware configuration may be a setting that impacts hardware. For example, the charging gap for an optical photoconductor or gap for a printhead may be too large or too small. Based on the cause identification engine 215 identifying an improper gap size as causing the defect, the remediation engine 220 may adjust the gap size. In some examples, the cause identification engine 215 may indicate the determined severity to the remediation engine, and the remediation engine 220 may adjust a setting until the severity in target images reaches a minimum.

The hardware configuration may be a setting that is able to remediate a part failure. In response to the cause identification engine 215 identifying a part failure that can be remediated by changing a setting, the remediation engine 220 may adjust the setting accordingly. For example, a location on the print product may be addressable by multiple nozzles on a printhead. Thus, in an example in which a nozzle is clogged or defective, the remediation engine 220 may adjust a print mask to reduce usage of the nozzle. The remediation engine 220 may compensate by adjusting the print mask to use other nozzles to address the affected locations.

The remediation engine 220 may adjust the hardware configuration by causing a failed part to be replaced. For example, the cause identification engine 215 may identify which part has failed. The remediation engine 220 may indicate the part identified by the cause identification engine 215 to a user and instruct the user to replace it. Alternatively, or in addition, the remediation engine 220 may indicate the identified part to another system (e.g., a system that manages printer maintenance). The other system may indicate the identified part to a technician, identify the printer in question, and instruct the technician to replace it. For example, the cause identification engine 215 may identify the cause of a defect as a damaged optical photoconductor, and the remediation engine 220 may request replacement of the optical photoconductor.

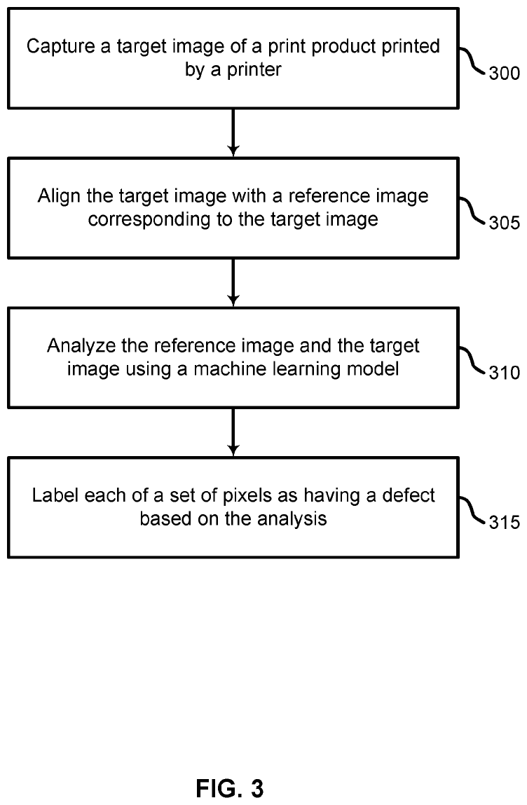

FIG. 3 is a flow diagram of an example method to label pixels having defects according to aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various sub-operations, or may be performed in conjunction with other operations described herein.

At operation 300, the system captures a target image of a print product printed by a printer. For example, operation 300 may include capturing an image in any of various electromagnetic spectrums or in any of various color spaces. In some cases, this operation may refer to, or be performed by, an imaging device as described with reference to FIGS. 1 and 2.

At operation 305, the system aligns the target image with a reference image corresponding to the target image. For example, operation 305 may include aligning the target image with the reference image based on detecting features in the images using a feature detection technique, based on correlating grayscale values, or the like. In some cases, this operation may refer to, or be performed by, a preprocessing engine as described with reference to FIG. 2.

At operation 310, the system analyzes the reference image and the target image using a machine learning model. For example, operation 310 may include using the reference image and the target image as inputs for the machine learning model, for example, without performing comparison operations on the reference and target images prior to providing them as inputs. When implemented, the machine learning model may output scores indicating whether each of various defects are present. There may be a plurality of scores for each pixel indicating whether each of the various defects are present in that pixel. In some cases, this operation may refer to, or be performed by, a defect identification engine as described with reference to FIGS. 1 and 2.

At operation 315, the system labels each of a set of pixels as having a defect based on the analysis. The label may indicate the type of defect. A label may be applied to each individual pixel of the plurality of pixels. For example, each score for each pixel may be compared to a threshold to determine whether a particular type of defect is present in that pixel. A label for a type of defect may be applied to a pixel based on the score for that type of defect meeting or exceeding the threshold. In some cases, this operation may refer to, or be performed by, a defect identification engine as described with reference to FIGS. 1 and 2.

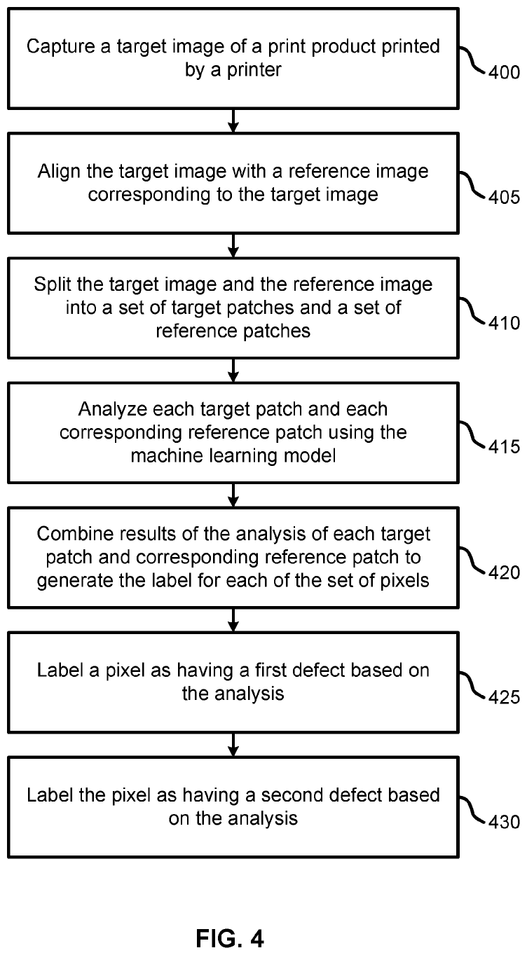

FIG. 4 is a flow diagram of another example method to label pixels having defects according to aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various sub-operations, or may be performed in conjunction with other operations described herein.

At operation 400, the system captures a target image of a print product printed by a printer. In some cases, this operation may refer to, or be performed by, an imaging device as described with reference to FIGS. 1 and 2. Operation 400 may be an example of, or include aspects of, the corresponding operation or operations described with reference to FIG. 3.

At operation 405, the system aligns the target image with a reference image corresponding to the target image. In some cases, this operation may refer to, or be performed by, a preprocessing engine as described with reference to FIG. 2. Operation 405 may be an example of, or include aspects of, the corresponding operation or operations described with reference to FIG. 3.

At operation 410, the system splits the target image and the reference image into a set of target patches and a set of reference patches. For example, a sliding window may be used to generate the target patches and reference patches from the target and reference images respectively. The sliding window may move by a sliding distance, which may be different for the horizontal and vertical directions. The patches may overlap with each other in some examples. In some cases, this operation may refer to, or be performed by, a preprocessing engine as described with reference to FIG. 2.

At operation 415, the system analyzes each target patch and each corresponding reference patch using the machine learning model. For example, each pair of patches may be concatenated to form an input vector that is provided to the machine learning model. When implemented, the machine learning model may output scores for each pixel in the target patch indicative of whether defects are present in that pixel. In some cases, this operation may refer to, or be performed by, a defect identification engine as described with reference to FIGS. 1 and 2. Operation 415 may be an example of, or include aspects of, the corresponding operation or operations described with reference to FIG. 3.

At operation 420, the system combines results of the analysis of each target patch and corresponding reference patch to generate the label for each of the set of pixels. For example, operation 420 may include stitching together analysis results for the various patches to produce a set of analysis results for the entire target image. For overlapping patches, operation 420 may include computing a maximum, minimum, average, median, or the like of each type of score for each pixel in the multiple patches and including the computed score in the stitched result. In some cases, this operation may refer to, or be performed by, a defect identification engine as described with reference to FIGS. 1 and 2.

At operation 425, the system labels a pixel as having a first defect based on the analysis. At operation 430, the system labels the pixel as having a second defect based on the analysis. For example, operation 425 may include comparing a first score for the pixel to a threshold to determine the first defect is present and adding the label for the first defect to the pixel based on the determination. Operation 430 may include comparing a second score for the pixel to a threshold to determine the second defect is present and adding the label for the second defect to the pixel based on the determination. The same or different thresholds may be used for each score. In some examples, labeling the pixel may include inserting a value into a defect map indicating the defect is present. The defect map may include a plurality of pixels and an indication for each pixel whether a defect is present. For example, there may be a set of bits or number for each pixel indicating whether a defect is present with each bit or number corresponding to a different type of defect and with different values for each bit or number indicating whether or not that type of defect is present in that pixel. In some cases, operation 425 or 430 may refer to, or be performed by, a defect identification engine as described with reference to FIGS. 1 and 2. Operation 425 or 430 may be an example of, or include aspects of, the corresponding operation or operations described with reference to FIG. 3.

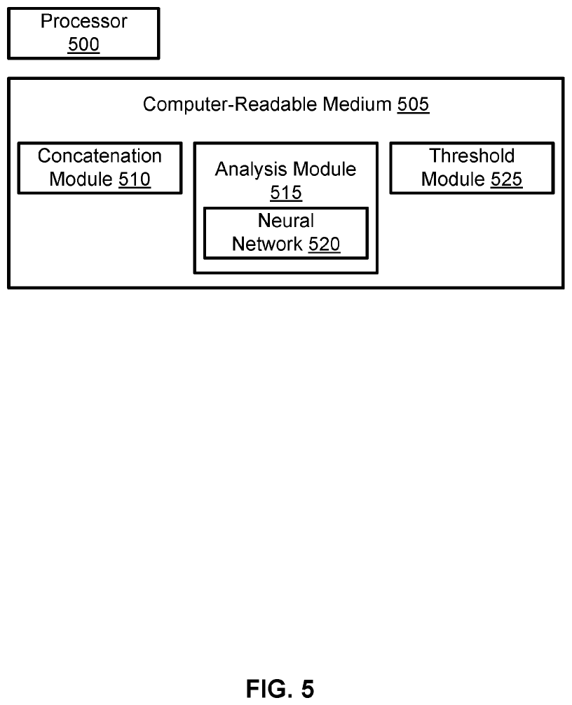

FIG. 5 is a block diagram of an example computer-readable medium 505 including instructions that, when executed by a processor 500, cause the processor 500 to label pixels having defects according to aspects of the present disclosure. The example shown includes a processor 500 and a computer-readable medium 505. The computer-readable medium 505 may be a non-transitory computer-readable medium, such as a volatile computer-readable medium (e.g., volatile RAM, a processor cache, a processor register, etc.), a non-volatile computer-readable medium (e.g., a magnetic storage device, an optical storage device, a paper storage device, flash memory, read-only memory, non-volatile RAM, etc.), and/or the like. The processor 500 may be a general-purpose processor or special purpose logic, such as a microprocessor (e.g., a central processing unit, a graphics processing unit, etc.), a digital signal processor, a microcontroller, an ASIC, an FPGA, a programmable array logic (PAL), a programmable logic array (PLA), a programmable logic device (PLD), etc.

The computer-readable medium 505 may include a concatenation module 510, an analysis module 515, and a threshold module 525. As used herein, a “module” (in some examples referred to as a “software module”) is a set of instructions that when executed or interpreted by a processor or stored at a processor-readable medium realizes a component or performs a method. The concatenation module 510 may include instructions that, when executed, cause the processor 500 to concatenate a target image of a print product printed by a printer with a reference image corresponding to the target image to produce an input vector. For example, the concatenation module 510 may cause the processor 500 to append grayscale values for the reference image to grayscale values for the target image (or vice versa) to form the input vector. When executed by the processor 500, the concatenation module 510 may be an example of or realize aspects of the preprocessing engine as described with reference to FIG. 2.

The analysis module 515 may include a neural network 520. The neural network 520 may be a machine learning model that includes indications of the weights and structure for the neural network 520. The analysis module 515 may cause the processor 500 to analyze the input vector using the neural network 520 to generate a plurality of scores for each pixel in the target image. For example, the input vector may be an input for the neural network 520, and the plurality of scores for each pixel may be outputs. Accordingly, the analysis module 515 may cause the processor 500 to implement the neural network 520 to generate the plurality of score for each pixel from the input vector. When executed by the processor 500, the analysis module 515 may be an example of or realize aspects of the defect identification engine as described with reference to FIGS. 1 and 2.

The threshold module 525 may cause the processor 500 to compare each score for each pixel to a threshold for that type of score to determine whether a defect corresponding to that score is present in that pixel. For example, the threshold module 525 may cause the processor 500 to determine a particular type of defect is present in a pixel based on the score for that type of defect and that pixel meeting the threshold or based on the score exceeding the threshold. When executed by the processor 500, the threshold module 525 may be an example of or realize aspects of the defect identification engine as described with reference to FIGS. 1 and 2.

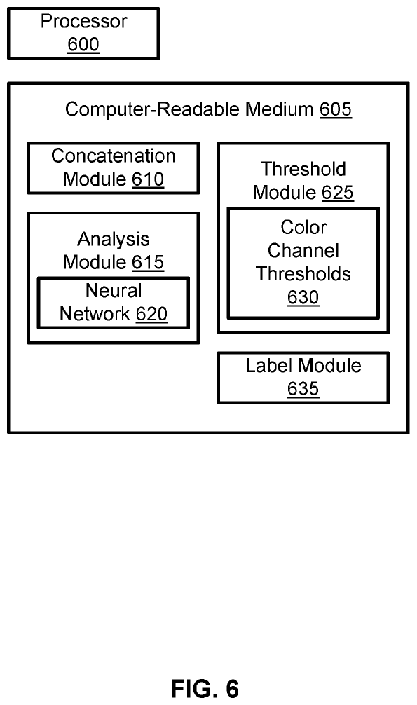

FIG. 6 is a block diagram of another example computer-readable medium 605 including instructions that, when executed by a processor 600, cause the processor 600 to label pixels having defects according to aspects of the present disclosure. The example shown includes a processor 600 and a computer-readable medium 605. The processor 600 or the computer-readable medium 605 may be examples of, or include aspects of, the corresponding element or elements described with reference to FIG. 5. The computer-readable medium 605 may include a concatenation module 610, an analysis module 615, a threshold module 625, and a label module 635.

The concatenation module 610 may be an example of, or include aspects of, the corresponding element or elements described with reference to FIG. 5. The concatenation module 610 may cause the processor 600 to concatenate a target image of a print product printed by a printer with a reference image corresponding to the target image to produce an input vector. When executed by the processor 600, the concatenation module 610 may be an example of or realize aspects of the preprocessing engine as described with reference to FIG. 2.

The analysis module 615 may be an example of, or include aspects of, the corresponding element or elements described with reference to FIG. 5. The analysis module 615 may include a neural network. The neural network 620 may be an example of, or include aspects of, the corresponding element or elements described with reference to FIG. 5. The neural network 620 may include a semantic segmentation network that, when the analysis module 615 is executed by the processor 600, generates a plurality of softmax outputs for each pixel in the target image based on the input vector. Each softmax output for a pixel may correspond to one of a plurality of labels. For example, each softmax output may be indicative of whether a particular type of defect identified by a label is present at that pixel. The neural network 620 may include a plurality of kernel sizes, which may allow information from surrounding pixels at various scales to be used to identify defects in a particular pixel.

Each softmax output may correspond to a type of defect for a particular color channel. The type of defect may be an increase in the color channel relative to the reference image or a decrease in the color channel relative to the reference image. In some examples, the target image and the reference image may each include a plurality of color channels in a first color space. Each softmax output may correspond to a type of defect for a particular color channel in a second color space. The neural network 620 may be trained to accommodate the difference in color spaces between the inputs and the outputs of the neural network 620. When executed by the processor 600, the analysis module 615 may be an example of or realize aspects of the defect identification engine as described with reference to FIGS. 1 and 2.

The threshold module 625 may be an example of, or include aspects of, the corresponding element or elements described with reference to FIG. 5. The threshold module 625 may include color channel thresholds 630. The threshold module 625 may cause the processor 600 to compare a softmax output for a pixel to the color channel threshold 630 for that type of softmax output to identify a defect in a color channel (e.g., to identify a defect in a color channel in the second color space). For example, each type of defect may be associated with a threshold, or there may be a single threshold for multiple types of defects. Accordingly, the color channel threshold 630 for each softmax output may be the color channel threshold 630 corresponding to the type of defect for a particular color channel that is associated with that softmax output. The threshold module 625 may cause the processor 600 to determine the type of defect for a softmax output is present based on the softmax output meeting the color channel threshold 630 or based on the softmax output exceeding the color channel threshold 630.

The label module 635 may cause the processor 600 to apply, to the pixel, a label that indicates the color channel that includes the defect. For example, the label module 635 may cause the processor 600 to generate a defect map, which may allow a plurality of labels to be assigned to each pixel. Based on the threshold module 625 causing the processor 600 to determine that a pixel has a color channel has a particular type of defect, the label module 635 may cause the processor 600 to modify the defect map to include an indication for that pixel of the color channel or type of defect detected at that pixel. For example, the label module 635 may cause the processor 600 to flip a first bit in the defect map based on detection of a defect due to an increase in a first color channel, to flip a second bit in the defect map based on detection of a defect due to a decrease in the first color channel, to flip a third bit in the defect map based on detection of a defect due to an increase in a third color channel, etc.

In this disclosure and the following claims, the word “or” indicates an inclusive list such that, for example, the list of X, Y, or Z means X or Y or Z or XY or XZ or YZ or XYZ. In the description, the statement that an element may include X, Y, or Z does not exclude other examples in which the element includes none of X, Y, and Z. Also, the phrase “based on” is not used to represent a closed set of conditions. For example, an operation that is described as “based on condition A” may be based on both condition A and condition B. In other words, the phrase “based on” shall be construed to mean “based at least in part on.”

The above description is illustrative of various principles and implementations of the present disclosure. Numerous variations and modifications to the examples described herein are envisioned. Accordingly, the scope of the present application should be determined only by the following claims.

What is claimed is:

1. A system comprising:
an imaging device to capture a target image of a print product printed by a printer;
a defect identification engine to:
analyze the target image and a reference image corresponding to the target image using a machine learning model, and
label each of a plurality of pixels as having a defect based on the analysis; and
a remediation engine to adjust a hardware configuration of the printer to remediate a cause of the defect in each of the plurality of pixels.

2. The system of claim 1, further comprising a cause identification engine to identify a cause of the defect based on the plurality of pixels labeled as having a defect, wherein the remediation engine is to adjust the hardware configuration to remediate the identified cause.

3. The system of claim 2, wherein the defect identification engine is to label the plurality of pixels as having a decreased color channel, wherein the cause identification engine is to identify a nozzle corresponding to the plurality of pixels having the decreased color channel, and wherein the remediation engine is to adjust a print mask to reduce usage of the nozzle.

4. The system of claim 2, wherein the cause identification engine is to determine a severity of the defect, and decide to remediate the defect based on the severity exceeding a threshold.

5. The system of claim 2, wherein the cause identification engine to identify a cause selected from the group consisting of an improper setting, a part failure remediable by changing a setting, and a part failure remediable by replacing a part.

6. A method, comprising:
capturing a target image of a print product printed by a printer;
aligning the target image with a reference image corresponding to the target image;
analyzing the reference image and the target image using a machine learning model; and
labeling each of a plurality of pixels as having a defect based on the analysis;
wherein a label is applied to each individual pixel of the plurality of pixels.

7. The method of claim 6, further comprising splitting the target image and the reference image into a plurality of target patches and a plurality of reference patches, wherein analyzing the reference image and the target image comprises analyzing each target patch and each corresponding reference patch using the machine learning model.

8. The method of claim 7, wherein labeling each of the plurality of pixels comprises combining results of the analysis of each target patch and corresponding reference patch to generate the label for each of the plurality of pixels.

9. The method of claim 6, wherein labeling the plurality of pixels comprises labeling a pixel as having a first defect and labeling the pixel as having a second defect.

10. A non-transitory computer-readable medium comprising instructions that, when executed by a processor, cause the processor to:
concatenate a target image of a print product printed by a printer with a reference image corresponding to the target image to produce an input vector, wherein the target image comprises a plurality of pixels;
analyze the input vector using a neural network to generate a plurality of scores for each pixel; and
compare each score for each pixel to a threshold for that type of score to determine whether a defect corresponding to that score is present in that pixel.

11. The computer-readable medium of claim 10, wherein the target image and the reference image each include a plurality of color channels, and wherein the instructions cause the processor to compare a score for a pixel to the threshold for that type of score to identify a defect in a color channel.

12. The computer-readable medium of claim 11, wherein the plurality of color channels is in a first color space and the color channel in which the defect is identified is in a second color space.

13. The computer-readable medium of claim 11, further comprising instructions that cause the processor to apply, to the pixel, a label that indicates the color channel that includes the defect.

14. The computer-readable medium of claim 10, wherein the neural network comprises a semantic segmentation network to generate the plurality of scores as a plurality of softmax outputs for each pixel, and wherein each softmax output for that pixel corresponds to one of a plurality of labels.

15. The computer-readable medium of claim 10, wherein the neural network comprises a layer that includes a plurality of kernel sizes.
